(19) United States
(12) Patent Application Publication
(10) Pub. No.: US 2012/0301651 A1
(43) Pub. Date: Nov. 29, 2012

(54) POLYISOCYANURATE-COATED PARTS AND THE USE THEREOF IN OFFSHORE APPLICATIONS

(75) Inventors: Jens Krause, Leverkusen (DE); Norbert Eisen, Koln (DE); Michael Merkel, Dusseldorf (DE)

(73) Assignee: Bayer Intellectual Property GmbH, Monheim (DE)

(21) Appl. No.: 13/514,839

(22) PCT Filed: Dec. 6, 2010
(86) PCT No.: PCT/EP2010/068980

§ 371 Date: Aug. 14, 2012

(30) Foreign Application Priority Data
Dec. 9, 2009 (DE) 102009057601.0

(51) Int. Cl. C09D 175/04; B32B 1/08

(52) U.S. Cl. 428/36.91; 524/590

(57) ABSTRACT

The invention relates to parts coated with polyisocyanurates and to the use thereof. Such parts are preferably used in the ocean.

The invention relates to parts coated with polyisocyanurates and to their use. Parts of this kind are used preferably in the sea.

In the insulation of parts/elements such as pipes, connecting elements, conveying systems, particularly in deep-sea pipes, polyurethanes are employed. The coating in this case may on the one hand be applied directly to the element to be coated (by casting, for example), as is carried out in the case of field joints. Alternatively, coating may also take place indirectly, with the coating being produced separately, and then applied to the element that is to be insulated, by screw connection, for example. This variant is carried out in the case of bend restrictors. These elements are used, for example, to convey oil and gas, with the polyurethane constituting an insulating coating. These polyurethanes are normally solid or syntactic. The term “syntactic polymers” generally encompasses plastics which comprise hollow fillers. In this context there are both hollow-glass fillers and hollow polymeric fillers. In the majority of cases the fillers are hollow glass beads. Syntactic polymers find use typically, on the basis of their advantageous compressive strength and temperature stability, as thermal insulation coatings, preferably in the offshore sector. Other applications in the offshore sector are bend stiffeners, bend restrictors, buoys, clamp systems, cables, flow traversal systems, and ballast tanks, and also X-Trees. With the exploration of increasingly deeper oil fields, the requirements imposed on the coatings are rising. Nowadays, materials are sought which on the one hand are elastic, in order to allow the elements to be easily deformed, for example; on the other hand, coatings with high temperature stability are sought, which resist hydrolysis by the water. In use nowadays are exclusively polyurethane elastomers, in some cases reinforced with epoxy resins. These systems possess both sufficient elasticity and temperature stability. However, the polyurethane elastomers exhibit very poor resistance to hydrolysis at temperatures above 50° C. Since present-day coatings are in use for up to 20 years and a temperature stability of >80° C., in some cases even >100° C., is required, the polyurethanes in use at present are inadequate. In many cases, therefore, polypropylene materials are used, that have the disadvantage that they cannot be applied in situ, i.e., on a boat, for example. The injection molding operation which has to be carried out is much too costly and inconvenient. Another disadvantage is that at very low temperatures, these plastics become brittle and shatter like glass. Another disadvantage is that many applications require the casting of complex geometries, where the injection technology/thermoplastic processing cannot be employed.

The object, therefore, was to provide a system which
a) can be processed in a simple casting process,
b) can be processed in situ as—as far as possible—a two-component reaction mixture,
c) neither contains nor gives off toxic substances,
d) can be processed at room temperature,
e) has a processing life of <5 minutes,
f) can be produced easily and quickly,
g) possesses good resistance to hydrolysis at high temperatures in water,
h) possesses an elongation at break of >10% at <60 Shore D and of >4% at ≧60 Shore D,
i) has a hardness of >40 Shore D and <90 Shore D.

This object has surprisingly been achieved with coated parts having specific polyisocyanurates as a coating component.

The invention provides coated parts coated directly or indirectly with polyisocyanurates, the polyisocyanurates being obtainable from:
a) a polyisocyanate based on diphenylmethane diisocyanate, having an NCO content of 20 to 34% by weight, which is liquid above 10° C., preferably above 30° C.,
   and
b) at least one compound which contains NCO-reactive groups, having a functionality of 1.8 to 6 and an OH number of 20 to 150, more preferably having a functionality of 3 and an OH number of 20-40, and optionally
c) chain extenders and/or crosslinking agents having a functionality of 2 to 3 and a molecular weight of 62 to 500,
   in the presence of
d) trimerization catalysts;
e) optionally auxiliaries and/or additives, such as, for example, dyes, UV stabilizers, silicone additives, zeolite pastes;
f) optionally epoxy resins in amounts of up to 50% by weight, based on polyol component (b).

The parts to be coated with polyisocyanurates (PIR) may have been pretreated, by varnish systems or adhesive layers, for example. The parts may also already have a coating before they are coated with polyisocyanurates.

The coating may on the one hand be applied directly to the element to be coated (by casting, for example), as is carried out preferably in the case of field joints. Alternatively, coating may also take place indirectly, with the coating being produced separately, and then applied to the element that is to be insulated, by screw connection, for example. This variant is carried out preferably in the case of bend restrictors.

By diphenylmethane diisocyanate (MDI) in this patent application is meant the isomers, more particularly 4,4′-MDI, and polymeric constituents, and also mixtures of the isomers together if desired with polymeric constituents.

Preference is given to using, in the offshore sector, coated parts in which as component (a) a prepolymer is used which contains isocyanate groups and is based on diphenylmethane diiso-cyanate, having an NCO content of 20% to 30% by weight and a viscosity of ≦2000 mPa*s at 25° C., which is liquid above −5° C., preferably above 5° C., more preferably above 10° C., which is obtainable from
i) at least one polyol having an OH number of 200 to 1000, preferably 400 to 800, more preferably 500 to 700 mg KOH/g, and a functionality of 1.8 to 4, which optionally contains 1,3-butanediol and/or 1,2-propylene glycol in amounts of not more than 2% by weight in each case, based on (a), and
ii) a diphenylmethane diisocyanate modified with carbodiimide groups and uretonimine groups, or a mixture of a diphenylmethane diisocyanate modified with carbodiimide groups and uretonimine groups and a polymeric isocyanate based on diphenylmethane diisocyanate.

The trimerization catalysts are also referred to as polyisocyanurate catalysts (PUR catalysts). The mechanism of the trimerization has still not been fully explained. A trimerization, however, takes place generally in the presence of anionic compounds, such as alkoxides, acetates or similar compounds, for example. The trimerization of organic isocyanates with aromatically bonded isocyanate groups is known. For instance, D. Dieterich, Houben-Weyl, Methoden der Organischen Chemie, volume E20, part 2, Georg Thieme Verlag, Stuttgart, 1987, pp. 1739-1751 comprehensively describes the discontinuous cyclotrimerization of isocyanates. Also described therein are a multiplicity of common PIR catalysts, such as oxides, alkanolates and phenolates, carboxylates, alkylammonium hydroxides and alkylammonium alkanolates, for example, or else Mannich bases.

Preferred PIR catalysts are, for example strong bases such as, for instance, quaternary ammonium hydroxides (benzyltrimethylammonium hydroxide), alkali metal hydroxides (KOH), alkali metal alkoxides (sodium methoxide). As well as strong bases there are also weak bases such as, for instance, alkali metal salts of carboxylic acid (sodium acetate, potassium 2-ethylhexoates, potassium adipates, sodium benzoate, N-alkylethyleneimines, tris(3-dimethylaminopropyl)-hexahydro-s-triazines, potassium phthalimides, and tertiary aminophenols as described in U.S. Pat. No. 4,169,921 (for example, 2,4,6-tris(N,N-dimethylaminomethyl)phenol). Examples of commercial catalysts for this are potassium acetates in ethylene glycol, such as Polycat 46 from Air Products; potassium 2-ethylhexoates in diethylene glycol/potassium octoates as Dabco K-15 from Air Products; mixtures of quaternary ammonium formic acid salts and also tertiary amines such as, for instance, DABCO TMR-5 from Air Products; hexahydro-1,3,5-tris(3-dimethylamino-propyl)triazines, available as Pel-Cat 9640 from Ele Company and Polycat 41 from Air Products; 2,4,6-tris(N,N-dimethylaminomethyl)phenol, available as Pel-Cat 9529 from Ele and TMR-30 from Air Products; Hexchem 977 from Hexchem, and Pel-Cat 9540A from Ele, tris(dimethylaminopropyl)-sym-hexahydrotriazine, such as, for instance, Polycat 60 (Abbott), potassium 2-ethyl hexoate, potassium octoate, such as, for instance, T-45 (M+T International), 2-dimethylaminomethylphenol, such as, for instance, DMP 10, 2,4,6-tris(dimethyl-aminomethyl)phenol, such as, for instance, DMP 30 (Rohm and Haas), etc.

The characteristic number of the reaction of (a) with (b) and (c) (in other words, the reaction of the NCO component with the compounds containing NCO-reactive groups) is preferably >300, more preferably >500.

Polyols b) used are preferably polytetrahydrofuran, polycarbonate polyol, and more preferably polyether polyols. Polyether polyols are prepared either by means of alkaline catalysis or by means of double metal cyanide catalysis or, optionally, in the case of a staged reaction regime, by means of alkaline catalysis and double metal cyanide catalysis, from a starter molecule and epoxides, preferably ethylene oxide and/or propylene oxide, and have terminal hydroxyl groups. Starters contemplated in this context include the compounds known to the skilled person that have hydroxyl groups and/or amino groups, and also water. The functionality of the starters in this context is at least 1.8 and not more than 6. It is of course also possible to use mixtures of two or more starters. Furthermore, mixtures of two or more polyether polyols can be used as polyether polyols. As a polyol component it is preferred to use polyether polyols, more preferably polyoxypropylene polyols.

The MDI-based prepolymers used are notable for their low viscosity at room temperature and also for their particular low-temperature stability. The NCO prepolymer which is used with preference begins to crystallize only below 0° C., preferably below −5° C., after 2 months of storage in closed containers. The viscosity of this NCO prepolymer at 25° C. in accordance with DIN EN ISO 11909 is less than or equal to 2000 mPa*s.

An advantage is that the isocyanate component has a high NCO content (in other words, for example, low modification), possesses a low viscosity, and at the same time also remains liquid at low temperatures and does not crystallize.

One modification of the MDI is, in principle, a reaction of the NCO group of the MDI. The formation of a prepolymer is a special case of modification, and relates to the reaction of a compound containing NCO-reactive groups with the NCO groups of the MDI.

Products liquid at room temperature with a viscosity of ≦2000 mPa*s at 25° C. are preferred. This corresponds usually to an NCO content of >20%.

In order to prevent crystallization of any free MDI still present in the MDI prepolymers, it is possible to add polycyclic MDI (also known under the term “polymeric MDI”) to the prepolymer. Large amounts of polymeric MDI, however, ought to be avoided.

It is advantageous that no catalysts containing heavy metal are used. Also an advantage from a process-engineering standpoint is that the volume flows of the isocyanate component and of the polyol component are similarly sized.

As additive it is preferred to use hollow microbeads in the polyisocyanurate, if syntactic polyisocyanurates are to be prepared.

The term “hollow microbeads” refers in the context of this invention to hollow organic and mineral beads. Hollow organic beads which can be used include, for example, hollow polymeric beads, made from polyethylene, polypropylene, polyurethane, polystyrene or a mixture thereof, for example. Hollow mineral beads may be produced, for example, on the basis of clay, aluminum silicate, glass or mixtures thereof. In their interior the hollow beads may have a vacuum or partial vacuum, or may be filled with air, inert gases, such as nitrogen, helium or argon, for example, or reactive gases, such as oxygen, for example. The hollow organic or mineral beads preferably have a diameter of 1 to 1000 mm, preferably of 5 to 200 mm. The hollow organic or mineral beads preferably have a bulk density of 0.1 to 0.4 g/cm³. They generally possess a thermal conductivity of 0.03 to 0.12 W/mK. As hollow microbeads it is preferred to use hollow glass microbeads. In one particularly preferred embodiment the hollow glass microbeads have a hydrostatic compressive strength of at least 20 bar. As hollow glass microbeads it is possible, for example, to use 3M Scotchlite® Glass Bubbles. As polymer-based hollow microbeads it is possible, for example, to use Expancel Products from Akzo Nobel.

Chain extenders/crosslinking agents used are compounds having a functionality of 2 to 3 and a molecular weight of 62 to 500. Use may be made of aromatic aminic chain extenders such as, for example, diethyltoluenediamine (DETDA), 3,3′-dichloro-4,4′-diaminodiphenylmethane (MBOCA), 3,5-diamino-4-chloroisobutyl benzoate, 4-methyl-2,6-bis(methylthio)-1,3-diaminobenzene (Ethacure 300), trimethylene glycol di-p-aminobenzoate (Polacure 740M), and 4,4′-diamino-2,2′-dichloro-5,5′-diethyldiphenylmethane (MCDEA). Particularly preferred are MBOCA and 3,5-diamino-4-chloroisobutyl benzoate. Aliphatic aminic chain extenders may likewise be used, exclusively or additionally. They often have a thixotropic effect on account of their high reactivity. Nonaminic chain extenders often used are, for example, 2,2′-thiodiethanol, propane-1,2-diol, propane-1,3-diol, glycerol, butane-2,3-diol, butane-1,3-diol, butane-1,4-diol, 2-methylpropane-1,3-diol, pentane-1,2-diol, pentane-1,3-diol, pentane-1,4-diol, pentane-1,5-diol, 2,2-dimethylpropane-1,3-diol, 2-methylbutane-1,4-diol, 2-methylbutane-1,3-diol, 1,1,1-trimethylolethane, 3-methyl-1,5-pentanediol, 1,1,1-trimethylolpropane, 1,6-hexanediol, 1,7-heptanediol, 2-ethyl-1,6-hexanediol, 1,8-octanediol, 1,9-nonanediol, 1,10-decanediol 1,11-undecanediol, 1,12-dodecanediol, diethylene glycol, triethylene glycol, 1,4-cyclohexanediol, 1,3-cyclohexanediol, and water.

As NCO-reactive compounds (b) it is possible with preference to use polyols having OH numbers in a range from 20 to 150, preferably 27 to 150, more preferably 27 to 120 mg KOH/g, and an average functionality of 1.8 to 6, preferably 2 to 3, more preferably 3. As polyols it is possible to use polyether, polyester, polycarbonate, and polyetherester polyols.

As polyol component (b) it is preferred to use polyether polyols, more preferably polyoxypropylene polyols.

Polyester polyols are prepared in a manner known per se by polycondensation from aliphatic and/or aromatic polycarboxylic acids having 4 to 16 carbon atoms, optionally from their anhydrides, and also, optionally, from their low molecular mass esters, including cyclic esters, the reaction component employed predominantly comprising low molecular mass polyols having 2 to 12 carbon atoms. The functionality of the synthesis components of the polyester polyols in this case is preferably 2, but in certain cases may also be greater than 2, with the components having functionalities of greater than 2 being used only in small amounts, so that the arithmetic number-average functionality of the polyester polyols is in the range from 2 to 2.5. Polycarbonate diols are a special case of a polyester polyol. Polycarbonate diols are obtained in accordance with the prior art from carbonic acid derivatives, as for example dimethyl carbonate or diphenyl carbonate, or phosgene, and polyols, by means of polycondensation.

The system may optionally be admixed with additives as well, in addition to the compound (b) containing NCO-reactive groups. Here, for example, mention may be made of catalysts (compounds which accelerate the reaction of the isocyanate component with the polyol component), surface-active substances, dyes, pigments, anti-hydrolysis stabilizers and/or antioxidants, and also UV protectants and epoxy resins. It is possible, furthermore, to add the blowing agents that are known from the prior art. It is preferred, however, for the isocyanate component and the compound containing the NCO-reactive groups not to contain a physical blowing agent. It is further preferred that no water is added to these components a) and b). Consequently, the components with particular preference contain no blowing agent, apart from minimal amounts of residual water which is present in polyols produced industrially. It is also possible for the residual water content to be reduced by addition of water scavengers. Examples of suitable water scavengers include zeolites. The water scavengers are used, for example, in an amount of 0.1% to 10% by weight, based on the total weight of the compound containing the NCO-reactive groups. Components a) and b) are typically mixed and reacted at a temperature of 0° C. to 100° C., preferably 15 to 60° C. Mixing may take place using the customary PUR processing machinery. In one preferred embodiment, mixing takes place by low-pressure machines or high-pressure machines.

The polyisocyanurates may be used, optionally with addition of hollow glass beads, for the insulation of offshore pipes or for the production of sockets for offshore pipes, and also for the production or coating of other parts and devices in the offshore sector.

Examples of other parts and devices in the offshore sector are generators, pumps, and buoys. An offshore pipe is a pipe which serves for conveying oil and gas. In this context, the oil/gas is conveyed from the sea floor to platforms, in boats/tankers, or else directly on land. The sockets are the connections between two pipes or pipe parts. The parts and devices or elements in the offshore sector are in continual contact with sea water.

The polyisocyanurates are preferably cast directly onto the surface of the part/element. Typical surfaces are composed, for example, of plastics, such as epoxy resin, polypropylene, and/or metals, such as aluminum, copper, steel or iron, for example. If the polyisocyanurate adheres poorly to these parts/elements, it is possible, for improved adhesion, to use/carry out, additionally, external adhesion promotors (adhesives, such as Cilbond from Cil or Thixon from Rohm & Haas), physical adhesion promotion (e.g., electron beam treatment), chemical vacuum vapor deposition, combustion of silanes (Silicoat), or internal adhesion promoters, such as epoxy silanes, for example.

The invention is elucidated in more detail using the examples below.

### EXAMPLES

### Starting Compounds

### Polyisocyanate Component:

The prepolymer used was obtained by reaction of the following components:

56.1% by weight of uretonimine-containing 4,4′-MDI (Desmodur® CD-S from Bayer MaterialScience AG) and
36.3% by weight of a mixture of about 2% by weight 2,2′-diphenylmethane diisocyanate (2,2′-MDI), about 53% by weight 2,4′-diphenylmethane diisocyanate (2,4′-MDI), and about 47% by weight 4,4′-diphenylmethane diisocyanate (4,4′-MDI)
7.6% by weight of polyether prepared from 1,2-propylene glycol and propylene oxide, having an OH number of 515 mg KOH/g.

The two isocyanate components were introduced. Thereafter the polyether was added. The mixture was stirred at 80° C. for 2 hours. The NCO content is 25.5% by weight and the viscosity at 25° C. is 170 mPa*s.

### Example 1

### Inventive

Reaction was carried out of 100 parts by weight of the prepolymer with 120 parts by weight of a polyol (OH number 27 mg KOH/g solids; functionality 3) in the presence of 0.044 part by weight of Dabco K15 (potassium octoate in solution in the polyol used) at approximately 35° C., and the reaction product was poured into a hot mold at 80° C. This gave a coating having a Shore D hardness of 55. This hardness is entirely sufficient for applications in the offshore sector.

### Example 2

### Inventive

Reaction was carried out of 100 parts by weight of the prepolymer with 30 parts by weight of a polyol (OH number 56 mg KOH/g solids; functionality 3) in the presence of 0.1 part by weight of Dabco K15 (potassium octoate in solution in the polyol used) at approximately 35° C., and the reaction product was poured into a mold having a temperature of 80° C. This gave a coating having a Shore D hardness of 85. Hardnesses of this kind are required for bend restrictors in the offshore sector.

### Example 3

### Comparative

Reaction was carried out of 38.5 parts by weight of the prepolymer with 61.5 parts by weight of a polyol component (60.44% by weight of a polyol (OH number 27 mg KOH/g solids; functionality 3) and 11.11% by weight of 1,4-butanediol and 14.27% by weight of a polyol (OH number 400 mg KOH/g solids; functionality 3) and also 9.6% by weight of an epoxy resin (viscosity at 25° C. in accordance with ISO 12058-1 of approximately 11 000 mPa*s, epoxy content in accordance with ISO 3001 184 g/equivalent) and 1.8 parts by weight of Thorcat 535 (mercury neodecanoate from Thor Chemicals)) at approximately 35° C., and the reaction product was poured into a mold having a temperature of 80° C. The Shore D hardness was 53. Hardnesses of this kind are needed for field joints.

TABLE

| | | | Example 1 | Example 2 | Example 3 |
|---|---|---|---|---|---|
| | | | (invention) | (invention) | (comparative) |
| Pot life | | [min] | 3.5 | 3 | 1.5 |
| Demolding time | | [min] | 5 | 5 | 5 |
| Hardness at 23° C. | DIN 53505 | Shore | 55 D | 85 D | 50 D |
| Hardness at 95° C. | DIN 53505 | Shore | 45 D | 79 D | 70 A |
| Hardness at 23° C. after 2 | DIN 53505 | Shore | 95 A/40 D | 80 D | 50 A |
| weeks' storage at 95° C. in | | | | | |
| water; * | | | | | |
| 6% Modulus | DIN 53504 | [MPa] | | 67 | |
| 6% Modulus after 2 weeks' | DIN 53504 | [MPa] | | 58 | |
| storage at 95° C. in water; * | | | | | |
| 10% Modulus | DIN 53504 | [MPa] | 13.2 | already | 8.7 |
| | | | | ruptured | |
| 10% Modulus after 2 weeks' | DIN 53504 | [MPa] | 4.8 | already | 0.3 |
| storage at 95° C. in water; * | | | | ruptured | |
| Strain at break | DIN 53504 | [MPa] | 17 | 69 | 20 |
| Strain at break after 2 weeks' | DIN 53504 | [MPa] | 8 | 61 | 4 |
| storage at 95° C. in water; * | | | | | |
| Elongation at break | DIN 53504 | [%] | 29 | 7 | 218 |
| Elongation at break after | DIN 53504 | [%] | 152 | 6 | 245 |
| 2 weeks' storage at 95° C. in | | | | | |
| water; * | | | | | |
| Water absorption after | based | [% by | 2.3 | 1.0 | 5.7 |
| 2 weeks in water at 95° C.; * | on | wt] | | | |
| and ** | ISO 62 | | | | |

* the samples were stored at 20° C. for 24 hours before the test
** the samples were removed from the water, the adhering water was removed with a cloth, and measurement took place immediately at 23° C.

In examples 1 and 2, the products display hardnesses which are of preferential desirability for field joints and in solid offshore insulation.

The polyisocyanurate from example 1, in comparison to the product from example 3, shows a significantly higher stability with respect to relatively high temperatures. It also absorbs only 2.3% by weight of water as against 5.7% by weight. Likewise, the hardness has dropped to 50 Shore A in example 3. The polyisocyanurate from example 1 still has a hardness of 40 Shore D (95 Shore A). The modulus at 10% decreases only by 64% in the case of example 1, by 97% in the case of example 3. Example 2 shows an extremely low water absorption and also an extremely high temperature stability.

1-3. (canceled)

4. A part coated with at least one polyisocyanurate, wherein said polyisocyanurate is obtained from:
a) a polyisocyanate based on diphenylmethane diisocyanate and having an NCO content of from 20% to 34% by weight and which is liquid above 10° C.;
and
b) at least one compound comprising NCO-reactive groups and having a functionality of 1.8 to 6 and an OH number of from 20 to 150;
in the presence of
c) trimerization catalysts.

5. The coated part of claim 4, wherein (a) is a prepolymer comprising isocyanate groups, wherein said prepolymer is based on diphenylmethane diisocyanate, has an NCO content of from 20% to 30% by weight, a viscosity of less than or equal to 2000 mPa*s at 25° C., is liquid above 30° C., and is obtained from:
i) at least one polyol having an OH number of from 200 to 1000 and a functionality of 1.8 to 4; and
ii) a diphenylmethane diisocyanate modified with carbodiimide groups and uretonimine groups, or a mixture of a diphenylmethane diisocyanate modified with carbodiimide groups and uretonimine groups and a polymeric isocyanate based on diphenylmethane diisocyanate.

6. An offshore pipe or a socket for an offshore pipe comprising the coated part of claim 4.
